(19) United States
(12) Patent Application Publication
(10) Pub. No.: US 2005/0251421 A1
(43) Pub. Date: Nov. 10, 2005

(54) Providing video interpreting services

(76) Inventors: Calvin Chang, (US); Daniel Kurywchak, (US); Thomas Nesbitt, (US); David Oakes, (US); Ravi Nemana, (US); Robert Chason, (US); Marbella Sala, (US)

Correspondence Address: FENWICK & WEST LLP, SILICON VALLEY CENTER, 801 CALIFORNIA STREET, MOUNTAIN VIEW, CA, 94041, US

(21) Appl. No.: 11/093,718

(22) Filed: Mar. 29, 2005

Related U.S. Application Data
(60) Provisional application No. 60/557,725, filed on Mar. 29, 2004.
(60) Provisional application No. 60/557,726, filed on Mar. 29, 2004.

(51) Int. Cl. G06F 17/60

(52) U.S. Cl. 705/2

(57) ABSTRACT

Remotely provided interpretation services enable a patient to communicate with one or more care providers in a health care organization. An interpreter can see and hear the communication between the patient and care provider, and interprets on behalf of the patient from a remotely located facility or decentralized location such as the interpreter's home. In an embodiment, the patient is provided with a mobile videoconferencing unit that can be transported with the patient during the duration of the patient's appointment as the patient moves from administrative to diagnostic to testing settings. In another embodiment, a system includes a database including patient language information, a scheduling system for reserving an interpreter, and a multipoint control unit (MCU) module for providing a secure connection for a teleconference between the patient and the interpreter.

### CROSS REFERENCE TO RELATED APPLICATIONS

This application claims the benefit of U.S. provisional application 60/557,725 and 60/557,726 each of which was filed Mar. 29, 2004 and is hereby incorporated by reference in its entirety; this application is related to U.S. patent application entitled “Mobile Video-Interpreting Mounting System” and filed Mar. 29, 2005, Attorney Docket 23540-9942 which is hereby incorporated by reference in its entirety.

### BACKGROUND

1. Field of the Invention

The present disclosure relates in general to telemedicine, and in particular to providing remote interpretation services to patients and providers in health care settings.

2. Background of the Invention

Health care organizations such as hospitals and clinics desire to provide health care services to patients that lack proficiency with the native languages of the organization's medical staff. In the United States, organizations that are principally engaged in the business of providing health care and which receive federal financial assistance to programs or activities risk losing their federal funding if they do not provide language interpretation services. Existing methods of providing interpretation services have significant shortcomings. Having a full-time staff of interpreters is costly and requires careful coordination between demand and supply. Friend and family interpreters are often not versed in medical terminology or concepts and lack neutrality in delivering health information. Outsourcing interpretation services is inefficient because transit and waiting time commonly consumes the bulk of an interpreter's time. While phone-based interpretation services overcome some of these problems, patients often communicate health information non-verbally, through facial expressions or hand gestures, for instance. For deaf patients, an interpreter must be able to see the patient in order to communicate with them.

### BRIEF DESCRIPTION OF THE INVENTION

The present invention overcomes the limitations of the prior art by providing on-demand video interpretation services to patients and health care providers in a health care setting. The methods and systems disclosed can be used to facilitate communication between patients and providers in a doctor's office, hospital, medical lab and/or other health care organization or setting, but can also be advantageously deployed in a variety of contexts and industries.

In an embodiment of the invention, remote interpreting services are provided to facilitate communications between a patient and health care provider. A request is received to schedule an appointment between a patient and health care provider, and a database is queried for language information associated with the patient. Responsive to language information associated with the patient, an interpreter is requested for an appointment period assigned to the patient. A secure connection is provided for data transmissions between the health care organization and an interpreter assigned to provide the interpretation service, also provided is a mobile videoconferencing that can transmit and receive data over a wireless connection to videoconferencing equipment.

Another embodiment of the invention includes a database of patient records, each containing patient language information, and a scheduling system for reserving an interpreter for remotely providing interpreting services on behalf of a patient during an appointment period. A multipoint control unit (MCU) module provides a secure connection for a teleconference between the patient and the interpreter, and a videoconferencing device receives and transmits data over the secure connection from the interpreter while located in a remote setting to the patient. The patient may be located at a plurality of settings in the health care organization during the duration of the appointment period.

### BRIEF DESCRIPTION OF THE DRAWINGS

The accompanying drawings illustrate embodiments and further features of the invention and, together with the description, serve to explain the principles of the present invention.

FIG. 1 depicts an environment in which video-based interpretation services may be provided to health care organizations in accordance with an embodiment of the invention.

FIG. 2 depicts a flow chart of the steps involved in providing video-based interpretation services in accordance with an embodiment of the invention.

### DETAILED DESCRIPTION OF THE DRAWINGS

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein. Although the present description refers to a health care organization and uses examples in a medical context, it will be understood that the techniques described herein are applicable wherever interpreter services are required and are not restricted to medical environments.

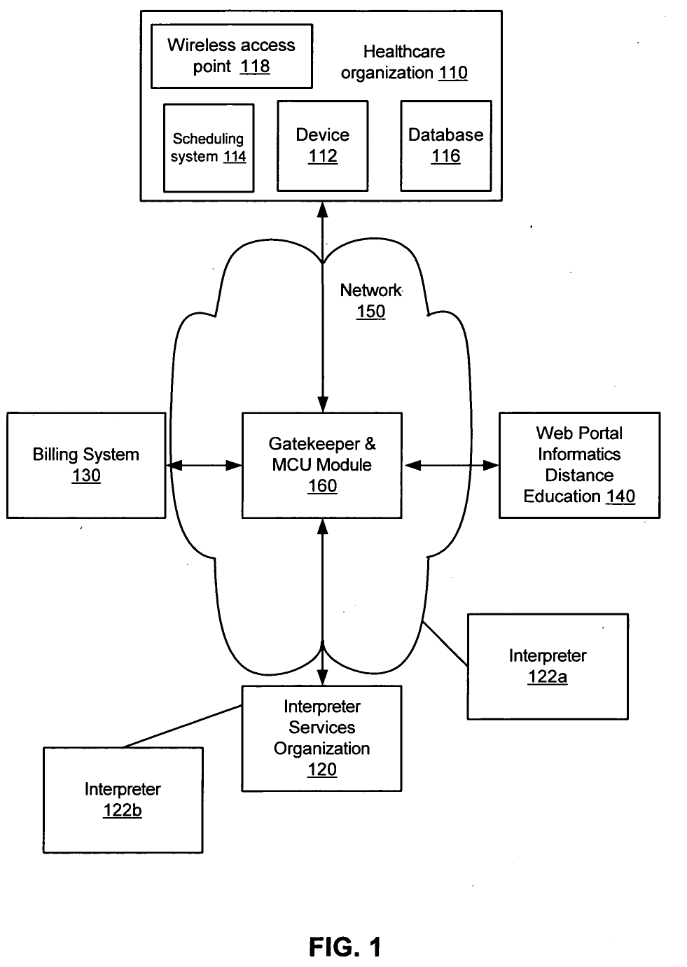

FIG. 1 depicts an environment in which video-based interpretation services are provided to health care organizations via a network. A health care organization 110 is connected to an interpreter services organization 120, a billing system 130, and a web portal 140 via a network 150. Those of skill in the art will recognize that FIG. 1 illustrates only an exemplary environment, and other embodiments of the environment may be arranged differently than the one in the figure. In general, the network 150 allows a person at the health care organization 110 to engage in a two-way, real-time audio-video conference with an interpreter 122, thereby allowing the health care organization 110 to meet its language interpretation needs while providing medical services to a patient.

The health care organization 110 comprises a hospital, clinic, doctor's office, or other organization where medical services are provided. The location of the health care organization 110 can be fixed or mobile. Although only one health care organization 110 is shown in FIG. 1, those of skill in the art will recognize that a typical environment can have multiple health care organizations 110. Furthermore, within a single healthcare organization 110, there may be several settings or points of contact where interpretation services are needed to facilitate communication between a doctor, nurse, or other caregiver or health care provider and a patient. For instance, during a visit to a doctor's office, the patient may interact with a receptionist upon check in or admission. If this is a first time visit, a nurse or other professional may take a preliminary intake of medical history and any current symptoms at an intake station as well as measure basic vital signs. At some point, the patient will likely move to a private room for a consultation with a physician or care practitioner. After consultation with the practitioner, if additional tests are ordered, the patient may need to go to a laboratory or testing site within the organization 110. If the patient has no proficiency in the language spoken at the organization 110, interpretation services are needed at each of the various administrative, patient intake, consultation, and/or diagnostic test settings.

The health care organization 110 of FIG. 1 includes a mobile videoconferencing device 112 to be used for interpretation as well as a plurality wireless access points 118 to provide wireless access to the device 112. In an embodiment, the patient is provided with the device 112 at the beginning of her visit and uses it to communicate with an interpreter 122 located at a remote location away from the site of the patient's visit, during her visit to the health care organization 110. The device 112 comprises a mobile videoconferencing device capable of supporting real-time audio and video conversations via data sent over a computer network and may comprise a device such as one of the devices described in U.S. provisional application 60/557,725 or 60/557,726, or U.S. patent application entitled “Mobile Video-Interpreting Mounting Device,” and filed Mar. 29, 2005, Ser. No. ______ Attorney Docket 23540-9942, each of which is incorporated above by reference in its entirety.

In one embodiment, the device 112 comprises an integrated videoconferencing device such as the Tandberg 1000 wall system made by Tandberg Corp. of Oslo, Norway. The integrated device 112 has a flat screen and incorporates a camera, display, microphone, and speakers, thus reducing the need for peripheral devices. In addition, the device 112 includes a CODEC enabling high-quality audio and video signals to be sent and received via a digital computer network. In other embodiments, different equipment such as the Via Video videophone made by Polycom of Pleasanton, Calif., the Ojo videophone made by Motorola of Schamburg, Ill., or other offerings relevant offerings by WorldGate Communications Inc. of Trevose, Pa. and/or software are used to provide the videoconferencing functionality. The device 112 includes wireless and/or wireline interfaces to enable the device 112 to receive and transmit signals sent through the network 150 to and from the interpreter 122. In an embodiment, the health care organization 110 comprises a wireless network that includes a standard or emerging technologies for wireless communications. The health care organization 110 includes several installed wireless access points 118 or routers that transmit signals that are accessible from various parts of the organization 110. In another embodiment, however, the health care organization 110 may supply a wireless link from an Ethernet or other wireline connection on demand, using a Pocket Router such as that offered by D-Link of Taipei, Taiwan.

The device 112 may be configured in any of a variety of ways. In one embodiment, the device 112 includes an adjustable pole mount and a wheeled base allowing for easy navigation and movement. The base has a footprint that is the size of an IV pole, allowing it to be easily stored and moved around with the patient. In an embodiment, the health care organization 110 has a supply of such devices 112 and deploys them on demand throughout the enterprise 110.

The mobile videoconferencing device 112 can be transported during a patient's visit to various locations visited by the patient. In an embodiment, a videoconference between an interpreter 122 patient is established and broadcast over the device 112 upon admission of the patient to the health care organization 110, providing the patient with use of the device and interpreter 122 throughout her visit. The device 112 is charged up and wirelessly maintains a connection to the interpreter 122 over the duration of the visit as the patient moves from location to location within the health care organization 110. Similarly, in a rehabilitation setting, a device 112 could be used by a patient who is asked for her progress at the beginning of a visit and receives instructions and treatment from one or more care providers throughout the visit. The device 112 could be used in a variety of other treatment settings such as a hospital where, for instance, a patient is admitted, then subjected to several stages of care, then provided instructions upon release.

The mobile videoconferencing device 112 has a battery that allows it to operate without being plugged in. This allows for complete freedom of movement of the unit 112 around the health care setting/organization 110. The unit 112 may be put into low power or power saving mode when it's not in use, and may also be charged or plugged in at a charging station or anytime it is in a stationary position and located near a power outlet. The battery and wireless interface of the device 112 make it ideal for medical environments such as hospital rooms and triage centers where it is undesirable to have a bulky device or network cables.

The health care organization 110 also includes a database 116 and a scheduling system 114 to provide patient appointments and schedule necessary interpretation services. The database 116 includes a plurality of patient records, each of which includes patient identification and language preference information. The records may comprise flat or other files, or files formatted to work with a relational database management system (RDBMS), or lightweight database access protocol (LDAP) system. When an appointment is requested for a patient, identification and language information is retrieved from the database 116 and used to make the appointment. The scheduling system 114 is used to identify scheduling options for the patient as well as to reserve an interpreter 122 for providing interpreting services on behalf of the patient during the patient's visit. In an embodiment, the scheduling system 114 is comprised of various proprietary or customized software modules such as that offered in an integrated healthcare IT system. The scheduling system 114 may also be used to contact an interpreter services organization 120 to reserve an interpreter 122 with the appropriate language skills for the patient. The scheduling system 114 may include, for instance, email or other messaging capabilities, or comprise a website interface for entering requests that are periodically provided to an interpreter services organization 120. In another embodiment, a user indicates the need for an interpreter 122 in a field of the patient's record in the database 116. On a regular basis, interpreter requests are routinely provided to the interpreter services organization 120 or directly to one or more interpreters 122, leading to confirmation of the reservation in any of a variety of conventional ways.

The network 150 provides communications between and among the other entities illustrated in the environment. In one embodiment, the network 150 is the Internet and uses wired and/or wireless links. All or part of the network 150 may include a cellular telephone network or other data network having a peering point with the Internet. The network 150 can also utilize dedicated or private communications links that are not necessarily part of the Internet, and make use of dedicated connections supplied on demand, for instance. These links can use standard networking technologies and may include 802.11, ISDN, DSL, ATM, and/or T-1 links. The data carried over the links can be packet-switched and/or circuit-switched. Moreover, the entities illustrated in FIG. 1 can communicate over the network 150 via conventional or emerging communications technologies such as multiprotocol label switching (MPLS), the transmission control protocol/Internet protocol (TCP/IP), the hypertext transport protocol (HTTP), the simple mail transfer protocol (SMTP), and/or the file transfer protocol (FTP). The entities can also engage in secure communications using technologies including the secure sockets layer (SSL), Secure HTTP and/or virtual private networks (VPNs). The transmitted video stream may utilize conventional or emerging data encodings such as 802.11 encryption. Data, images, files, and messages may also be provided in a variety of formats including MPEG, JPEG, hypertext markup language (HTML), and extensible markup language (XML). In addition, the entities can use custom or dedicated data communication technologies to communicate.

The networking functionality can be provided by one or more Internet service providers (ISPs), including a local exchange or other telecommunications carrier. Data transmitted over the network 150 may be protected using one or more security technologies, such as encryption. Alternatively, the videoconferencing services may be provided over a proprietary, secured network such as the Glowpoint network provided by Wire One Technologies of King of Prussia, Pa. or by a service provider such as MSERGY of Plano, Tex. In one embodiment, the network is provided by a single ISP (although that ISP might subcontract to other ISPs for bandwidth). The ISP may use a dedicated network for providing videoconferencing services, and provide quality of service (QoS) guarantees to the health care organization and other entities involved in the language interpretation service, to ensure that the data transmission is at a rate and quality level high enough to videoconferencing services. In an embodiment, interpreting services are marketed and sold by the ISP as part of a value-added telecommunications offering. Interested customers on the broadband carrier's website are directed to a link to a portal 140 which features a separate suite of services for sale, including video interpreting services for health care applications and other potential billable services that can be provided at a distance such as Telemedicine, Distance Education, Continuing Medical Education, Grand Rounds (a formal hospital meeting at which physicians discuss interesting medical cases) and On-line Education. The ISP may also have a large sales force that can market the video interpreting services.

The network 150 includes a gatekeeper and MCU module 160 that supports the interpreter services furictionality. As used herein, the term “module” refers to software and/or hardware for providing the functionality attributed to the module. One of skill in the art will recognize that the module 160 does not necessarily correspond to a physical entity on the network. Rather, the module 160 can be formed from decentralized components operating at one or more of the other entities illustrated in FIG. 1. The gatekeeper and multipoint control unit (MCU) module 160 supports videoconference calls between the interpreter 122 and patient at the health care organization 110. The MCU 160 sets up a videoconferencing session according to either an ISDN (H.320), IP (H.323), related video over IP, or other protocol between the healthcare provider and the interpreter 122, registers the endpoints of the call, and manages resources to balance demands on the network 150. In the case of an ISDN call, the MCU 160 may obtain a 10-digit conference call number and distribute that to the interpreter 122. In one embodiment, the health care organization 110 also receives the call information for each call. In another, the health care organization 110 relies on a pool of ISDN videoconferencing lines and each call is assigned one of the lines in the pool as needed. In the case of an IP call, an IP address or phone number-like alias is obtained and distributed by the MCU 160 to the relevant parties. In an embodiment, a portion of the IP address represents the health care organization 110 and a portion represents a device address, making it easy for the health care organization 110 to find the correct videoconference when needed. A videoconferencing service provider may use other proprietary methods to establish the connection.

In one embodiment, the communications session is point-to-point between the patient at the healthcare organization 110 and the interpreter 122 associated with the interpreter services organization 120. In another embodiment, the communications session is point-to-multipoint and involves three or more locations. In an embodiment, the MCU module 160 is provided by an ISP that supplies the network 150 connection.

The interpreter services organization 120 provides interpreters 122 to the health care organization 110. The organization 120 may comprise a national provider such as Language Line Services, with offices in California and Illinois, or other local or individual providers. These interpreters 122, provided by the interpreter services organization 120 or otherwise, are located remotely from the health care organization 110, that is, they provide services while situated in a different location than the patient and health care provider. This location may comprise a site or campus of the health care organization 110 separate from the location of the patient's visit, or the interpreter's home, or another location entirely. Although only one interpreter services organization 120 is shown in the environment of FIG. 1, different embodiments of the invention may include multiple interpreter organizations 120. The interpreter services organization 120 can be centralized (e.g., having interpreters located at a call center), or distributed (e.g., having interpreters working from their homes). The interpreters themselves 122 may be affiliated with one or more interpreter services organizations 120.

In an embodiment, to provide interpreting services from home or other decentralized location such as a videoconference center, an interpreter 122 uses a computer, computing device, and/or specialized videoconferencing equipment such as a webcam to connect to the network 150. Through a high-speed connection, the interpreter 122 logs on to a secure VPN prior to establishing a connection to the patient, ensuring that any transmission between the interpreter 122 and the patient will be secured and less susceptible to unwanted interception or eavesdropping. The computer is equipped with peripherals to support videoconferencing including a headset or microphone and a camera, and a monitor on which the interpreter 122 can watch an image of the patient and view other files. In another embodiment, the interpreter 122 uses specialized videoconferencing equipment such as that supplied by Polycom or other provider to establish a connection to the healthcare organization. Or, each interpreter 122 could be provided with a videoconferencing device 112 similar to one used at a health care organization 110. Providing video interpreting services from interpreter homes or other decentralized locations has a number of advantages. It reduces overhead and administrative costs, by avoiding the need for a centralized facility and allowing interpreters to be “on-call” and provide their services as dictated by real-time demand. Because the conferences take place over decentralized, ad hoc connections, it also reduces the risk that any individual videoconference will be hacked or intercepted.

The interpreters 122 may specialize in one or more services required by the health care organization. For example, an interpreter 122 may specialize in interpreting between the native language of the health care providers and one or more foreign languages spoken by the patients. In another example, the interpreters 122 further specialize in interpreting conversations related to specific medical conditions. Thus, a particular interpreter 122 might specialize in interpreting conversations for Spanish-speaking cancer patients.

In one embodiment, the interpreters 122 associated with the interpreter services organization 120 are fulltime employees. In another embodiment, some or all of the interpreters are contract employees. Moreover, the interpreter services organization 120 can be affiliated with a particular health care organization 110, or an independent enterprise. In one embodiment, the interpreter services organization 120 provides services to multiple health care organizations 110 and makes use of full time and/or contract employees depending upon the needs of the health care organizations 110. Moreover, in one embodiment the interpreter services organization 120 subcontracts the interpreter services to another organization.

In one embodiment, some or all of the interpreters 122 make use of computer interpretation technologies. The interpreters 122 may utilize speech recognition software (such as IBM's Dragon Naturally Speaking or the DECIPHER text-to-speech technology made by SRI of Stanford, Calif.) coupled to a language interpretation program (such as Alta Vista's Babel Fish Interpretation or Google's Language Tools), thus eliminating the need for live language interpreters. A virtual computer image of an interpreter 122 can be generated and customized to match each patient's demographics (race, age, sex, culture, dress etc), such as the computer generated images offered by ERATO Kitano Symbiotic System's robotic receptionist and Carnegie Mellon University's roboceptionist project (described at http://www.roboceptionist.com/). In addition, other technologies can be utilized to provide the illusion of empathy in a medical setting. Sega's Magical VEngine is a real-time voice analysis tool that can work closely with facial animations to produce realistic mouth movements based on the emotions and feelings of an animation character. An embodiment of the invention uses these technologies for at least some of the interpretation sessions.

In the environment shown in FIG. 1, a billing system 130 is connected to the gatekeeper and MCU module 160 in the network 150. The billing system 130 captures information regarding usage of interpretation services, performs accounting, and generates bills to the relevant parties (e.g., the health care organization 110, individuals within the health care organization 110, and/or insurance companies). Those of skill in the art will recognize that the billing system 130 can include one or more computer systems for performing this functionality.

In one embodiment, the interpretation services are sold at a per minute or other measured rate and the revenues are shares between the ISP, interpreter services organization 120, health care organization 110, and/or other entities. In another embodiment, the services are sold at a flat rate or a mix of a flat and measured rates. In addition, there can be multiple tiers of charges—a base rate for scheduled services and a premium rate for emergencies. Harder to find languages or other service segments, might be billed at different rates depending on demand and supply. Videoconferencing equipment and space may also be leased, sold independently or in conjunction with the interpretation services.

The environment of FIG. 1 also shows a web portal 140 coupled to network 150. The web portal 140 provides a web-based interface to the interpretation system and serves as the main point of contact between health care organizations 110 and interpretation services organizations 120, and aggregates demand and supply. For example, in one embodiment, the web portal 140 provides a web-based interface with which a healthcare provider can indicate the desired interpretation services and/or select an individual interpreter. In addition, the web portal 140 can act as a gateway to other services, such as distance education and informatics. In an embodiment, the web portal 140 can comprise a health portal or a virtual private network site through which a videoconference connection can be established. Accounts and reservations for service can be electronically transacted. The exchange of Protected Healthcare Information (PHI) for the Treatment, Payment, or Healthcare Operations (TPO) of a patient between health care organizations must meet all HIPAA guidelines before any data is transmitted.

The environment of FIG. 1 can support a business operated by a health care organization 110, interpreter services organization 120, ISP and/or another entity. For example, a health care organization 110 having an existing relationship with an interpreter services organization 120 can contract to provide interpretation services to other health care organizations 110. Likewise, an ISP having the required networking capabilities can team with an interpreter services organization 120 to provide interpretations to health care organizations. Other embodiments of the business will be apparent to those of skill in the art.

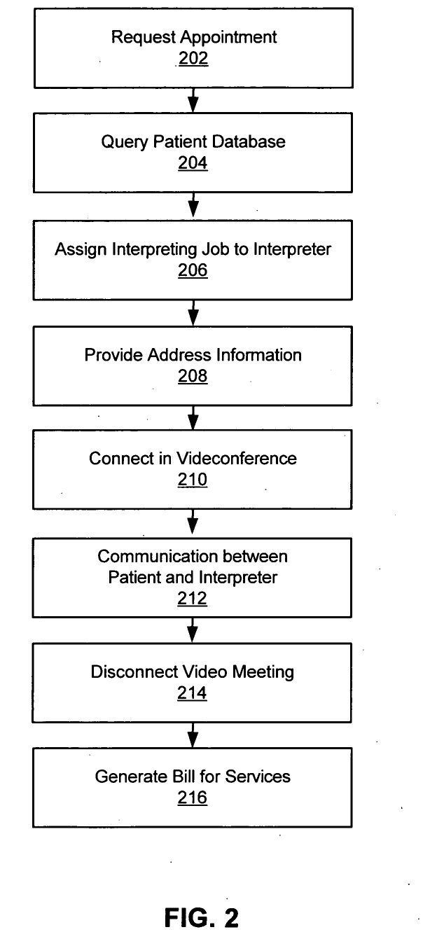

Now taking FIG. 2, an exemplary process of providing video interpretation services begins when a patient or client of a health care organization calls the health care organization to request 202 an appointment. A coordinator identifies the patient's linguistic needs by querying 204 a patient database that contains medical record information. Patient medical record information, including the patient's linguistic needs, is downloaded to a repository on a regular basis, for instance every 24 hours. An electronic healthcare delivery module is used to review all interpretation services requests made as reflected in the repository over the period and prepares a summary of needs. No interpreter service is provided to the health care organization until verification has been made by the clinic that the patient has arrived. At that point the electronic healthcare delivery module determines that video interpretation will be utilized and notifies a dispatcher who coordinates among interpreter services organization. The dispatcher assigns 206 the job to an interpreter services organization or a contract interpreter. The interpreter is then put on standby. The health care organization locates a teleconferencing device to be used and a MCU module is used to create a videoconference call. The relevant addressing information is provided to the interpreter. The address information may be in the form of an IP or ISDN address. In an embodiment, where a Tandberg unit is used, a user may initiate the videoconference by dialing a number on the unit and pressing a button. A call-manager tool automatically assigns an IP address to the videoconference call and provides the information to the interpreter, who using standard Internet meeting or related technology, establishes a videoconference.

The interpreter and health care organization connect 210 in the videoconference provided by a MCU. The gatekeeper/MCU module keeps track of the minutes used by the health care organization for billing during each session. The patient communicates 212 with the interpreter using a mobile videoconferencing device that allows the patient to watch real-time images of the interpreter as well as see a small image of herself as viewed by the interpreter on the display. The interpreter introduces her/himself to the patient and explains that she will be interpreting via video and that confidentiality is being maintained. In an embodiment, the interpreter also explains that no recording of the session is being made, for privacy reasons. If there are no concerns, the interpreting begins. This initial set up phase may take place upon admission of the patient to the health care organization, beginning with an administrative encounter. The patient keeps the device with her as she moves through the stages of her visit, for instance to any of a variety of administrative, intake, treatment, and diagnostic settings. When the patient is waiting or otherwise does not need the services of the interpreter, in an embodiment, the interpreting unit goes into a low power mode or the audio is turned off, signaling to the interpreter that she should remain on-call but is not immediately needed.

When the patient is seeing a doctor or other care provider for a sustained period of time, the videoconferencing is positioned to capture a full view of the doctor and patient. During such a consultation the patient and interpreter may operate in different modalities. For instance, there may be times when the patient is being examined, and for privacy reasons the camera on the device is turned away so that the interpreter cannot see the patient. There may be other times when the provider is delivering test results or instructions to the patient, and the interpreter may interrupt to slow the provider down, and make sure the patient understands the instruction. When there is a dialogue between the patient and provider, the interpreter may maintain eye contact alternatively with each. If there is a break in the appointment and the provider leaves the room but has not completed the visit, the interpreter may indicate that the audio will be turned off. The interpreter maintains visual contact and resumes interpreting upon the return of the provider. The doctor may order additional tests or follow up work for the patient. The patient may then proceed to another portion of the health care organization, transporting the videoconferencing unit along with her there. Upon completion of the visit, the interpreter disconnects 214 the video session. The gatekeeper and MCU module records the duration of the call. It then provides the information to a billing system, which uses it to generate 216 a bill to the health care organizer. The revenue is shared between the electronic healthcare delivery module provider, the organization that provided interpreting services, and the billing system provider.

The above description is included to illustrate the operation of the certain embodiments and is not meant to limit the scope of the invention. From the above discussion, many variations will be apparent to one skilled in the relevant art that would yet be encompassed by the spirit and scope of the invention.

1. A method of remotely providing interpreting services to facilitate communications between a patient and health care provider associated with a health care organization, the method comprising:
receiving a request to schedule an appointment between the patient and health care provider;
querying a database for language information associated with the patient;
responsive to language information associated with the patient, requesting an interpreter for an appointment period assigned to the patient;
providing a secure connection for data transmissions between the health care organization and an interpreter assigned to provide the interpretation service; and
providing a mobile videoconferencing device for communicatively connecting, via the secure connection, the assigned interpreter and health care organization for the appointment period, wherein the patient and health care provider are collocated in the health care organization during at least a portion of the appointment period and wherein the mobile videoconferencing device comprises an integrated display and microphone, and interface for transmitting and receiving data over a wireless connection.

2. The method of claim 1, wherein the step of providing the secure connection further comprises:
establishing a videoconference between the assigned interpreter and the patient upon admission of the patient to the health care organization; and
providing the mobile videoconferencing device to the patient for use by the patient in a plurality of settings within the health care organization and by the patient while in communication with a plurality of health care providers.

3. The method of claim 2, wherein a setting of the plurality of settings comprises at least one of: a patient intake setting, a patient treatment setting, a diagnostic test setting, a rehabilitation setting, and an administrative setting.

4. The method of claim 1, wherein the interpreter uses a computer aided interpretation engine to interpret communications between the patient and health care provider.

5. The method of claim 1, wherein the interpreter comprises a computer generated virtual interpreter comprising a computer aided interpretation engine configured to provide interpretations of communications between the patient and health care provider through a graphical user interface representing a person.

6. The method of claim 1, wherein the mobile videoconferencing device comprises a chassis for mounting the display, and the microphone and speaker are housed in the chassis.

7. The method of claim 1, wherein the interpreter provides interpreting services from a remote location.

8. The method of claim 1, wherein the remote location comprises the interpreter's home.

9. The method of claim 1, wherein the mobile videoconferencing device comprises a recorder for recording communications of the patient and health care provider captured by the camera and microphone.

10. The method of claim 1, further comprising providing a plurality of wireless access points distributed throughout the health care organization to which the mobile videoconferencing device can wirelessly transmit data to be provided to the interpreter.

11. The method of claim 1, wherein the mobile videoconferencing device comprises a videoconferencing unit adjustably mounted to a pole attached to a wheeled base for transport of the mobile videoconferencing device.

12. A system for providing remote interpreting services for communications between a patient and a plurality of health care providers during a patient visit to a health care organization, the system comprising:
a database comprising a plurality of patient records, each patient record containing patient language information;
a scheduling system for, responsive to a request for an appointment for the patient and language information for the patient stored in a patient record, reserving an interpreter for remotely providing interpreting services on behalf of the patient during an appointment period provided for the patient;
a multipoint control unit (MCU) module for providing a secure connection for a teleconference between the patient and the interpreter; and
a mobile videoconferencing device for receiving and transmitting data over the secure connection from the interpreter to the patient, while the patient is located in a plurality of settings in the health care organization during the duration of the appointment period.

13. The system of claim 12, further comprising a billing module for calculating charges associated with providing a remote interpreter for the appointment period.

14. The system of claim 12, wherein the videoconferencing device is configured to be wirelessly connected to a plurality of access points in a wireless network in the health care organization.

15. The system of claim 12, wherein a setting of the plurality of settings comprises at least one of: a patient intake setting, a patient treatment setting, a consultation setting, a diagnostic test setting, a rehabilitation setting, and an administrative setting.

16. The system of claim 12, wherein the remote setting comprises the interpreter's home.

17. A method of providing interpretation services for communications between a patient and a health care provider for a health care organization, the method comprising:
receiving a request for an interpreter for interpreting on behalf of the patient during an appointment period from a health care organization;
responsive to the request, reserving the services of a selected interpreter for serving the health care organization during the appointment period;
providing a broadband connection for secure transmission of video and audio data between an interpreting facility associated with the selected interpreter and the health care organization during the appointment period, wherein the interpreting facility comprises a private home; and
generating billing data based on actual usage by the health care organization of the services of the selected interpreter to interpret communications between the patient and health care provider.

18. The method of claim 18, further comprising:
providing a mobile videoconferencing device for communicatively connecting the selected interpreter and health care organization for the appointment period.

19. The method of claim 18, wherein the mobile videoconferencing device comprises an integrated display, camera, and interface for transmitting and receiving data over a wireless connection
